(19) United States
(12) Patent Application Publication
(10) Pub. No.: US 2015/0212515 A1
(43) Pub. Date: Jul. 30, 2015

(54) NUMERICAL CONTROL SYSTEM AND NUMBERICAL CONTROL DATA GENERATION METHOD

(71) Applicants: Toshiba Kikai Kabushiki Kaisha, Chiyoda-ku, Tokyo-to (JP); Toshiba System Technology Corporation, Fuchu-shi, Tokyo-to (JP)

(72) Inventors: Yasunori Kato, Numazu-shi (JP); Masayuki Harada, Fuchu-shi (JP)

(21) Appl. No.: 14/417,003

(22) PCT Filed: Jul. 26, 2013
(86) PCT No.: PCT/JP2013/070331

§ 371 Date: Jan. 23, 2015

(30) Foreign Application Priority Data
Jul. 31, 2012 (JP) 2012-169710

(51) Int. Cl. G05B 19/4099

(52) U.S. Cl. CPC G05B 19/4099; G05B 2219/50336

(57) ABSTRACT

A numerical control system to be used for a machining device machining a machining target into a desired shape, according to an embodiment, the system includes: a storage unit storing a plurality of basic shapes therein; a display unit displaying a plurality of selection shapes selected by an operator from among the basic shapes; and a computing unit extracting areas enclosed by line segments between intersections of contour lines of the selection shapes as unit shapes, respectively, when the selection shapes overlap with one another and to combine a plurality of selection unit shapes selected by the operator from among the unit shapes, thereby generating a contour of the desired shape.

### CROSS REFERENCE TO RELATED APPLICATIONS

This application is based upon and claims the benefit of priority from the prior Japanese Patent Application No. 2012-169710, filed on Jul. 31, 2012, the entire contents of which are incorporated herein by reference.

### FIELD

The embodiments of the present invention relate to a numerical control system and a numerical control data generation method.

### BACKGROUND

Conventionally, a numerical control device used for a machine tool that machines an object along a contour defines a contour of a machining shape by combining basic shapes.

For example, in Patent Document 1, a machining shape is represented with a combination of plural types of basic shapes and the types, positions, and dimensions of the basic shapes are set as parameters. The parameters are bound using signs that indicate how to combine the basic shapes, thereby creating a code that represents a contour shape. In Patent Document 2, basic shapes are copied by sequentially overlapping one another and displayed, and the basic shapes are coupled in the order of copy to define one new contour shape.

When a complex machining shape is to be generated, a technique that enables to generate a contour of the machining shape by sequentially selecting line segments between intersections of a plurality of basic shapes is also applied.

When a contour of a machining shape is defined by combining the basic shapes as mentioned above, operating procedures for setting parameters of the basic shapes or for coupling the basic shapes to generate the contour of the machining shape become quite complicated and numerous.

Also, when the line segments of the basic shapes are sequentially selected to generate a contour of a machining shape, operating procedures become difficult to understand and cumbersome. For example, when some necessary line segments are not selected, a contour line does not close and thus the machining shape cannot be generated. Furthermore, when the line segments of the basic shapes are to be selected according to the machining order, a contour generation work needs to be performed in consideration of object machining procedures.

When the operating procedures become complicated, a long time is required to obtain a desired machining shape. Furthermore, the operating procedures may differ according to operators and thus the operators need to be skilled in the operation of a numerical control device to generate a contour of the machining shape in a short time.

The present invention has been achieved to solve the above problems and an object of the present invention is to provide a numerical control system and a numerical control data generation method that are simple in the operation procedures and that can generate a contour of a machining shape in a short time.

### SUMMARY OF THE INVENTION

A numerical control system to be used for a machining device machining a machining target into a desired shape, according to an embodiment, the system comprises: a storage unit storing a plurality of basic shapes therein; a display unit displaying a plurality of selection shapes selected by an operator from among the basic shapes; and a computing unit extracting areas enclosed by line segments between intersections of contour lines of the selection shapes as unit shapes, respectively, when the selection shapes overlap with one another and to combine a plurality of selection unit shapes selected by the operator from among the unit shapes, thereby generating a contour of the desired shape.

### BRIEF DESCRIPTION OF THE DRAWINGS

FIG. 1A is a block diagram showing a configuration of the numerical control system 1 according to a first embodiment of the present invention;

FIG. 1B is a conceptual diagram schematically showing functions of the numerical control system 1;

FIG. 2 is a flowchart showing an operation of the numerical control system 1 performed when a contour of a machining shape is to be generated;

FIGS. 3 to 9 are diagrams showing screens displayed on the display 70 of the numerical control system 1 when a contour of a machining shape is to be generated;

FIG. 10A is a block diagram showing a configuration of the numerical control system 1 according to a second embodiment of the present invention; and

FIG. 10B is a conceptual diagram schematically showing functions of the numerical control system 1 according to the second embodiment.

### DETAILED DESCRIPTION

Embodiments will now be explained with reference to the accompanying drawings. The present invention is not limited to the embodiments.

### First Embodiment

A numerical control system 1 to be used for a machine tool or the like that machines a machining target into a desired shape defines a contour (graphic information) of a machining shape and a route (machining information) of a tool using CAD/CAM (Computer Aided Design/Computer Aided Manufacturing) and converts the graphic information and the machining information into a machining program executable by the numerical control system.

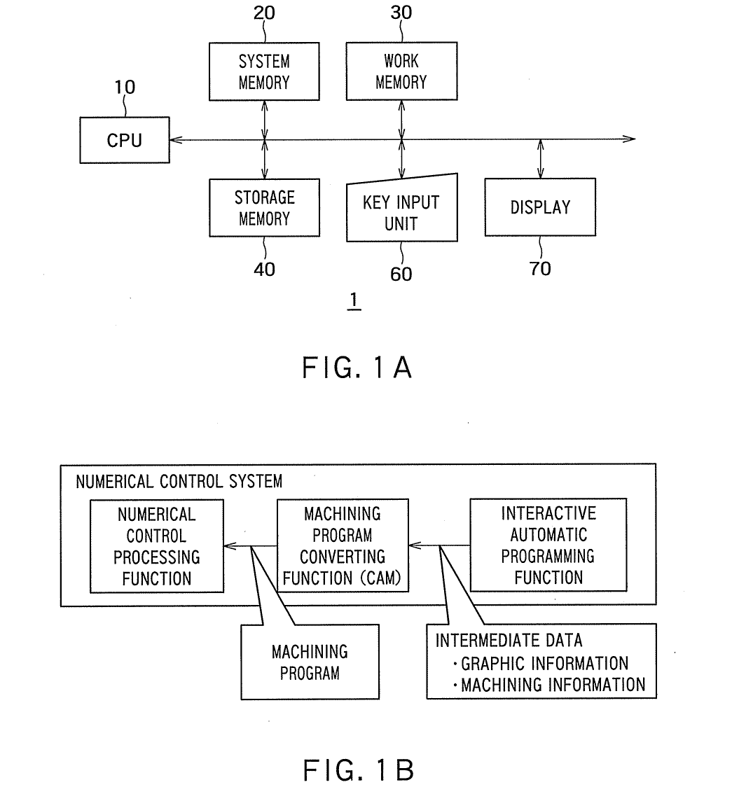

FIG. 1A is a block diagram showing a configuration of the numerical control system 1 according to a first embodiment of the present invention. FIG. 1B is a conceptual diagram schematically showing functions of the numerical control system 1.

As shown in FIG. 1A, the numerical control system 1 includes a CPU (Central Processing Unit) 10 serving as a computing unit, a system memory 20, a work memory 30, and a storage memory 40 serving respectively as a storage unit, a key input unit 60 serving as an operation unit, and a display 70 serving as a display unit.

The system memory 20 is, for example, a ROM (Read Only Memory) and has a system program that controls the numerical control system 1 in its entirety, a system program for interactive automatic programming, and the like stored therein. The work memory 30 is, for example, a RAM (Random Access Memory) and is a load area for a machining program and data and a work area at the time of machining program execution, in which the machining program, the data, and the like are temporarily stored. The storage memory 40 is, for example, an HDD (Hard Disc Drive) or an SSD (Solid State Drive) and has a machining program converted by the interactive automatic programming, basic shapes used when a contour of a machining shape is to be formed, and the like stored therein. The system memory 20 can be constituted by an HDD.

The key input unit 60 is, for example, a keyboard and is operated by an operator to input information into the numerical control system 1.

The display 70 can be, for example, a CRT (Cathode Ray Tube) or a liquid crystal display. The display 70 can be a touch panel display device. In this case, the display 70 also has a function of an operation unit and thus the key input unit 60 is not necessarily required. Although the numerical control system 1 further includes a servo control unit, the servo control unit is not directly relevant to the present embodiment, and accordingly illustrations and explanations thereof will be omitted.

As shown in FIG. 1B, the numerical control system 1 has functions such as an interactive automatic programming function, a machining program converting function (CAM (Computer Aided Manufacturing)), and a numerical control processing function. The interactive automatic programming function is a function to generate graphic information and machining information. The machining program converting function is a function to convert the graphic information and the machining information to a machining program executable by the numerical control system. The numerical control processing function is a function to drive a machining device based on the machining program. With these functions, the numerical control system 1 can machine an object into a desired shape.

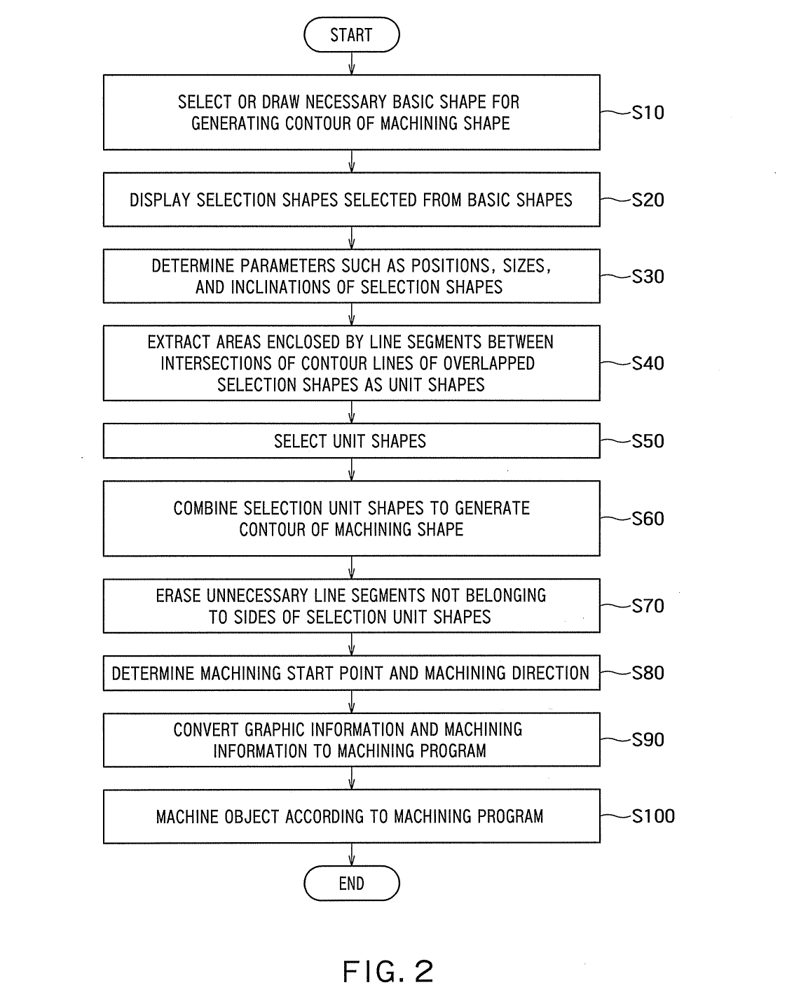

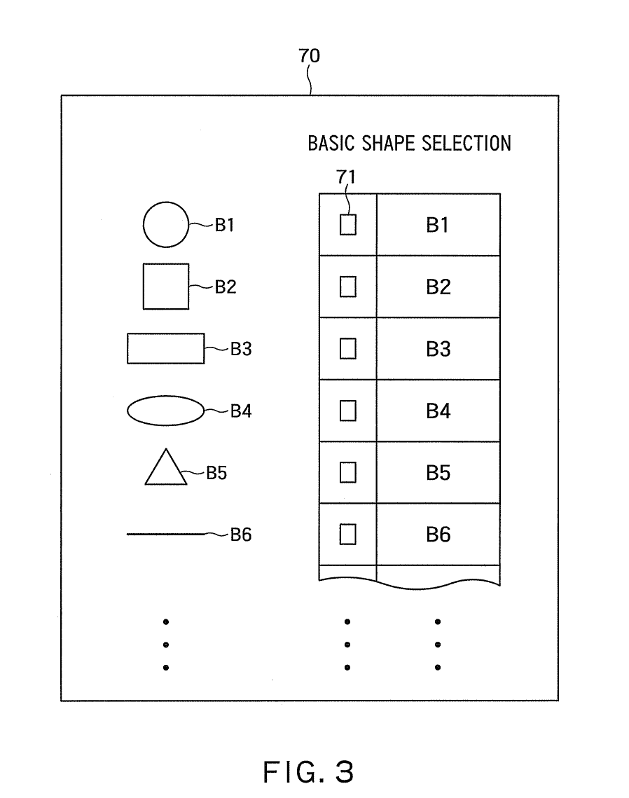

FIG. 2 is a flowchart showing an operation of the numerical control system 1 performed when a contour of a machining shape is to be generated. FIGS. 3 to 9 are diagrams showing screens displayed on the display 70 of the numerical control system 1 when a contour of a machining shape is to be generated. An operation of the numerical control system 1 performed when a contour of a machining shape is to be generated is explained with reference to FIGS. 2 to 9.

An operator first selects necessary basic shapes for generating a contour of a machining shape from among a plurality of basic shapes stored in the storage memory 40 (S10). At that time, the display 70 displays the basic shapes stored in the storage memory 40 or codes corresponding to the basic shapes. The operator selects basic shapes or codes displayed on the display 70 by operating the key input unit 60.

For example, basic shapes B1 to B6 are displayed to be selectable on the display 70 as shown in FIG. 3. The operator operates the key input unit 60 and checks boxes 71 corresponding to basic shapes to be selected. This enables the necessary basic shapes for generating the machining shape to be selected from among the basic shapes B1 to B6. In this example, “B1” to “B6” are allocated to the basic shapes as identifiers. It suffices that the identifiers “B1” to “B6” are codes that enable the basic shapes to be distinguished from one another and the identifiers “B1” to “B6” are not limited thereto.

The basic shapes can be previously created and registered in the storage memory 40. Alternatively, the operator can draw the basic shapes when a contour of a machining shape is to be generated. The basic shapes are arbitrary graphics such as a line, a curve, a circle, an ellipse, a rectangle, and a hole.

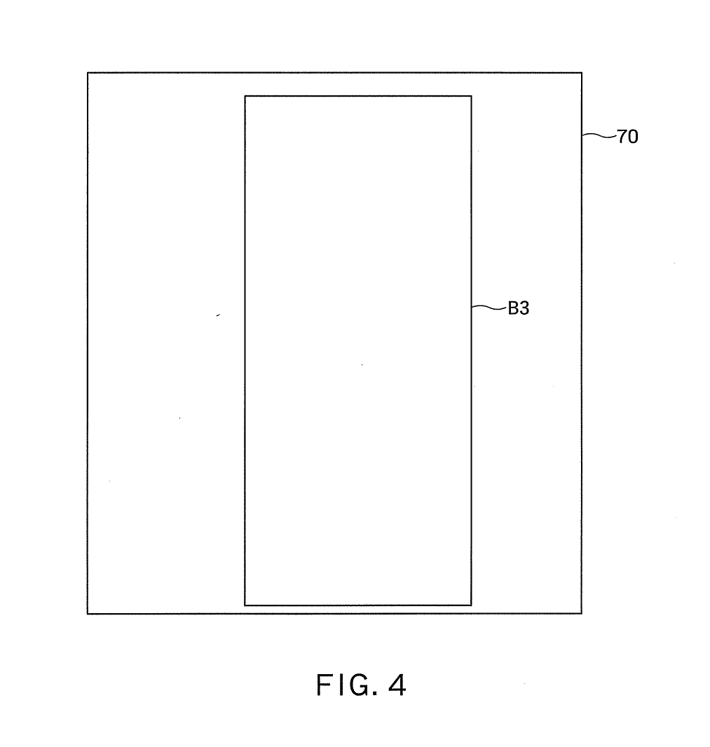

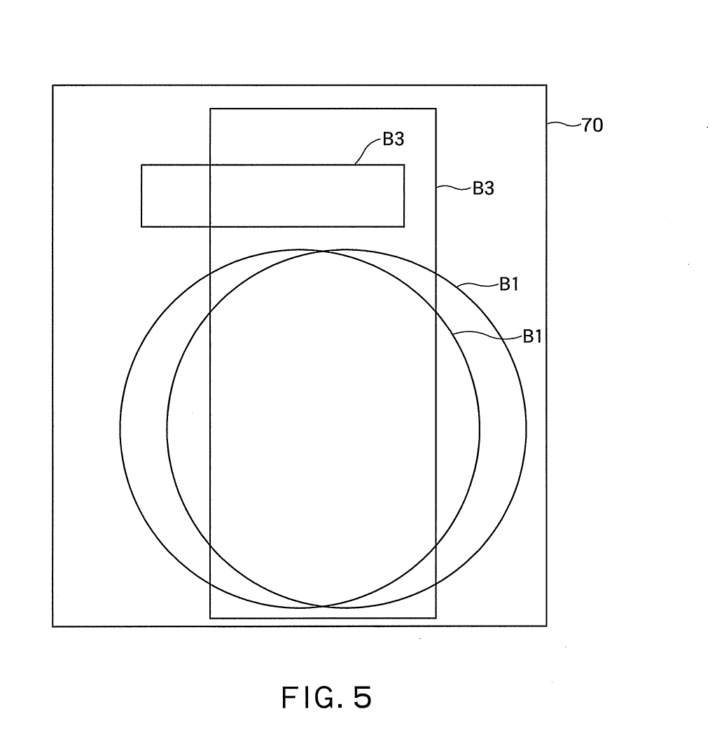

When the basic shapes are selected, the display 70 displays the basic shapes (hereinafter, also “selection shapes”) selected by the operator from among the basic shapes stored in the storage memory 40 (S20). For example, when the basic shape B3 is selected, the basic shape B3 is displayed on the display 70 as shown in FIG. 4. When another basic shape is to be further selected, it suffices that the operator operates the key operation unit 60 to return to a selection screen at Step S10 and selects again a basic shape. When some of the selection shapes displayed on the display 70 are unnecessary, the operator operates the key operation unit 60 to delete or cancel the unnecessary selection shapes at Step S20. The operator operates the key operation unit 60 while viewing the display 70, thereby discarding and selecting basic shapes to determine the necessary selection shapes for generation of the machining shape. In the present embodiment, for example, two circular shapes B1 are selected and two rectangular shapes B3 are selected as shown in FIG. 5. At that time, positions, sizes, and inclinations of the basic shapes B1 and B3 are not determined on the display 70. When the display 70 is a touch panel type, the operator can select the basic shapes by simply touching the basic shapes themselves displayed on the display 70.

The selected two basic shapes B1 are denoted by B1a and B1b for convenience and the selected two basic shapes B3 are denoted by B3a and B3b for convenience.

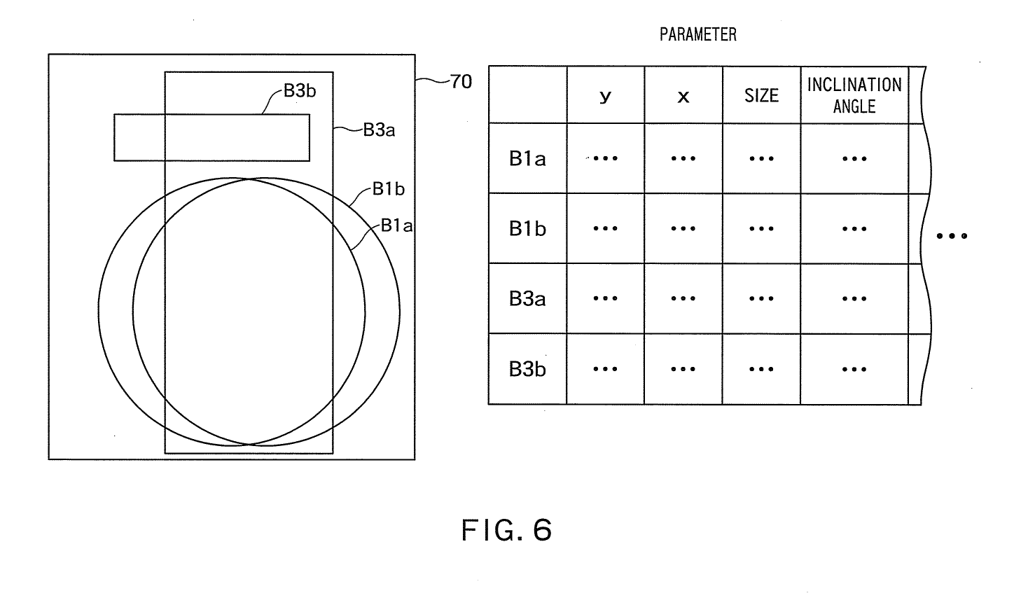

After having determined the basic shapes B1a, B1b, B3a, and B3b as the selection shapes by operating the key operation unit 60, the operator determines parameters such as the positions, the sizes, and the inclinations of the selection shapes B1a, B1b, B3a, and B3b (S30). The operator inputs numerical values of the parameters of the selection shapes using the key operation unit 60. For example, as shown in FIG. 6, the operator inputs coordinates (x, y), sizes (diameters, lengths of diagonals, or the like), and inclination angles to determine the positions, the sizes, and the inclinations of the selection shapes, respectively.

Alternatively, the operator can bring one of the selection shapes to an active state using the key operation unit 60 to determine the position, the size, and the inclination of the active selection shape. For example, when a pointing device such as a mouse is attached to the key operation unit 60, the operator can change the positions, the sizes, and the inclinations of the selection shapes B1a, B1b, B3a, and B3b using the pointing device.

Furthermore, when the display 70 is a touch panel type, the operator can determine the positions, the sizes, and the inclinations of the selection shapes through an operation on the touch panel.

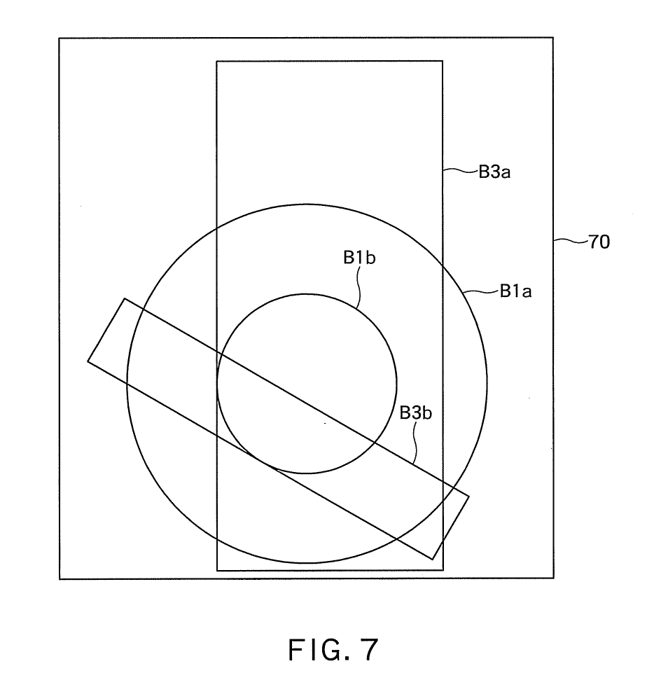

When the positions, the sizes, and the inclinations of all the selection shapes are determined, the operator fixes the parameters such as the positions, the sizes, and the inclinations of the selection shapes B1a, B1b, B3a, and B3b using the key operation unit 60. The selection shapes B1a, B1b, B3a, and B3b are thereby determined, for example, as shown in FIG. 7.

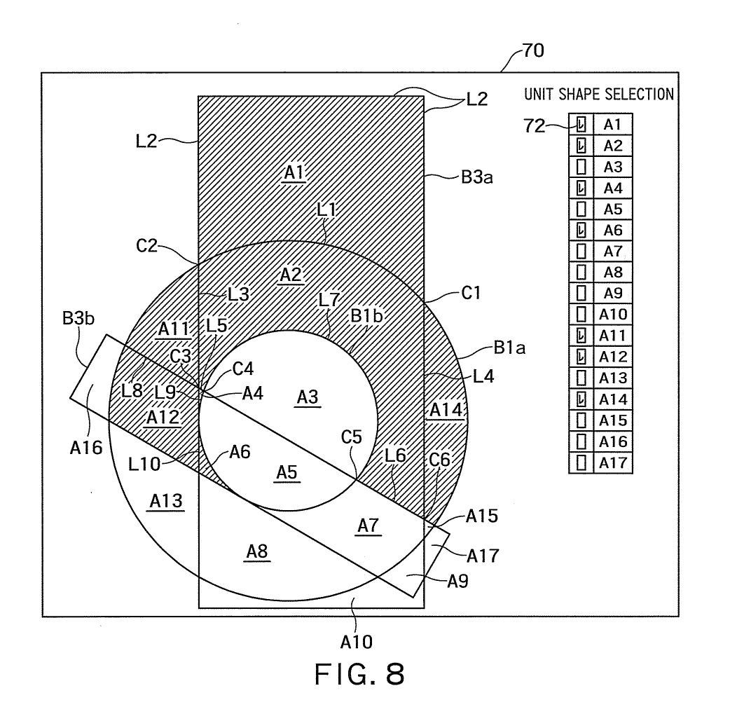

When the parameters of the selection shapes are fixed, the CPU 10 extracts areas enclosed by line segments between intersections of contour lines of overlapped ones of the selection shapes B1a, B1b, B3a, and B3b as unit shapes, respectively (S40). For example, as shown in FIG. 8, there are line segments L1 and L2 between intersections C1 and C2 of the selection shapes B1a and B3a. An area A1 enclosed by the line segments L1 and L2 is extracted as a unit shape. The area A1 is a minimum area (plane) capable of being segmented by the selection shapes B1a, B1b, B3a, and B3b. That is, no line segments of the selection shapes B1a, B1b, B3a, and B3b are included in the area A1 and the area A1 cannot be divided any more. The area A1 is a two-dimensional plane enclosed by the line segments L1 and L2.

Considering intersections C3 and C6 of the selection shapes B3a and B3b and intersections C4 and C5 of the selection shapes B3b and B1b as well as the intersections C1 and C2, an area A2 enclosed by a line segment L3 between the intersections C2 and C3, a line segment L4 between the intersections C1 and C6, a line segment L5 between the intersections C3 and C4, a line segment L6 between the intersections C5 and C6, and a line segment (a circular arc) L7 between the intersections C4 and C5 is also extracted as a unit shape. Similarly, areas A3 to A17 enclosed by line segments between intersections of the contour lines of the selection shapes B1a, B1b, B3a, and B3b are extracted as unit shapes, respectively. The areas A1 to A17 are hereinafter referred to as “unit shapes” A1 to A17, respectively.

The unit shapes A2 to A17 are minimum areas capable of being segmented by the selection shapes B1a, B1b, B3a, and B3b similarly to the unit shape A1. That is, the unit shapes A2 to A17 include no line segments of the selection shapes B1a, B1b, B3a, and B3b and the unit shapes A2 to A17 cannot be divided any more. The unit shapes A2 to A17 are two-dimensional planes, respectively.

When there is only a single selection shape or when the selection shapes do not overlap with one another, the operation at Step S40 is of course not required. In this case, it suffices that the operator selects a machining start point and a machining direction as explained below with respect to the single selection shape or each of the selection shapes.

As an example of identifiers, “A1” to “A17” are allocated to the unit shapes by the CPU 10. It suffices that the identifiers “A1” to “A17” are codes that enable the unit shapes to be distinguished from one another and the identifiers “A1” to “A17” are not limited thereto.

The CPU 10 displays a unit shape selection table on the display 70 to enable the unit shapes A1 to A17 to be arbitrarily selected as shown in FIG. 8. The operator selects one or plural ones of the identifiers “A1” to “A17”, thereby selecting the unit shapes A1 to A17 corresponding to the identifiers (S50). For example, the operator checks boxes 72 corresponding to ones of the unit shapes A1 to A17 to be selected. In the present embodiment, the unit shapes A1, A2, A4, A6, A11, A12, and A14 are selected as shown in FIG. 8.

The CPU 10 changes colors or hatchings of the selected unit shapes (hereinafter, also “selection unit shape”) A1, A2, A4, A6, A11, A12, and A14. The operator can thereby easily recognize the selection unit shapes.

Next, the CPU 10 combines the selection unit shapes A1, A2, A4, A6, A11, A12, and A14 to generate a contour of a desired shape (S60). More specifically, the CPU 10 erases the line segments respectively shared by the selection unit shapes A1, A2, A4, A6, A11, A12, and A14 to bring the selection unit shapes A1, A2, A4, A6, A11, A12, and A14 to a single closed contour. For example, as shown in FIG. 8, there is a line segment L1 between the selection unit shapes A1 and A2. There is the line segment L3 between the selection unit shapes A2 and A11. There is the line segment L4 between the selection unit shapes A2 and A14. There is the line segment L5 between the selection unit shapes A2 and A4. The CPU 10 erases the line segments L1, L3 to L5, and L8 to L10 located between ones of the selection unit shapes A1, A2, A4, A6, A11, A12, and A14 to connect the selection unit shapes A1, A2, A4, A6, A11, A12, and A14. One contour is thereby generated.

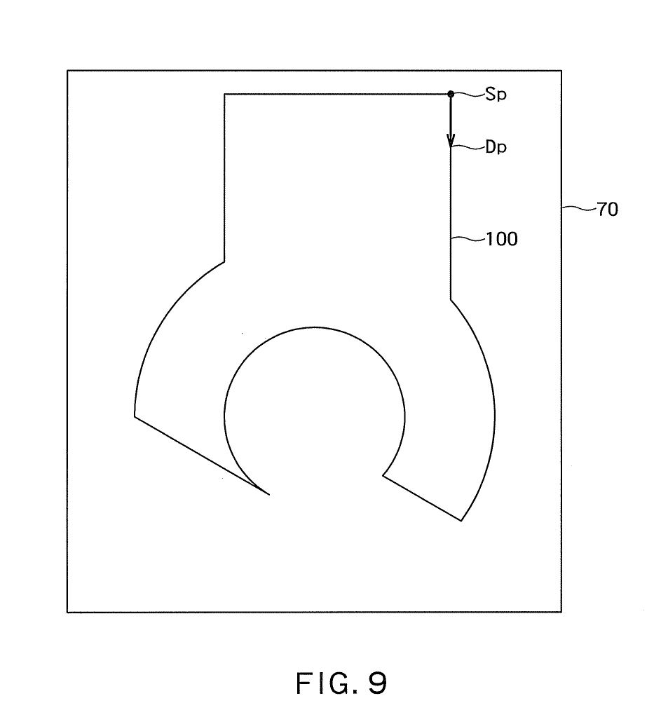

Furthermore, the CPU 10 erases unnecessary line segments not belonging to sides of the selection unit shapes (S70). That is, CPU 10 erases line segments belonging only to unselected unit shapes. A machining shape 100 having a single closed contour is thereby obtained as shown in FIG. 9.

Next, the CPU 10 determines a machining start point and a machining direction according to selection by the operator (S80). For example, the operator operates the key input unit 60 to specify one point Sp of the machining shape 100 as the machining start point. Furthermore, the operator specifies another point Dp of the machining shape 100 to specify the machining direction. For example, a direction toward the point Dp specified subsequent to the machining start point Sp (a direction shown by an arrow in FIG. 9) is the machining direction. The contour, the machining start point, and the machining direction of the machining shape 100 are thereby determined. That is, the graphic information and the machining information mentioned above are determined.

Thereafter, the numerical control system 1 converts the graphic information and the machining information to a machining program having a form executable by the numerical control system using an automatic programming language of the CAD/CAM or the like (S90). The machine tool can machine an object into a desired shape by machining the object according to the machining program (S100).

As described above, the numerical control system 1 according to the present embodiment extracts minimum areas enclosed by line segments between intersections of contour lines of basic shapes as unit shapes and combines selected unit shapes, thereby generating a contour of a machining shape. That is, after selecting the basic shapes and setting the parameters, an operator can generate a desired machining shape only by selecting unit shapes displayed in two-dimensional planes as explained with reference to FIG. 8. Therefore, the operator does not need to select line segments of the basic shapes and does not need to consider the selection order of the line segments or the basic shapes. As a result, the numerical control system 1 according to the present embodiment has simple operating procedures, does not require a skilled technique, and can generate a contour of a machining shape in a short time.

When the numerical control system 1 includes the pointing device as mentioned above, an operator can easily and smoothly select the basic shapes and the unit shapes only by clicking the basic shapes or the unit areas with the pointing device. That is, use of the pointing device eliminates the need to display the identifiers allocated to the basic shapes or the unit shapes.

The positions, the sizes, and the inclinations of the selection shapes can be also changed easily with the pointing device. For example, an operator can move a selection shape by dragging the selection shape with the pointing device. The operator can change the size or the inclination of a selection shape by dragging one end of the selection shape with the pointing device.

When the display 70 is a touch panel display device, an operator can easily and smoothly select the basic shapes and the unit shapes only by touching the basic shapes or the unit shapes on the display 70. Use of the touch panel display device also eliminates the need to display the identifiers allocated to the basic shapes or the unit shapes.

The positions, the sizes, and the inclinations of the selection shapes can be also changed easily on the display 70. For example, an operator can move a selection shape by dragging the selection shape on the display 70. The operator can change the size of a selection shape by widening or narrowing the distance between two fingers (a pinch operation) while keeping the two fingers in contact with the display 70. The operator can change the inclination of a selection shape by turning two fingers while keeping the two fingers in contact with the display 70.

### Second Embodiment

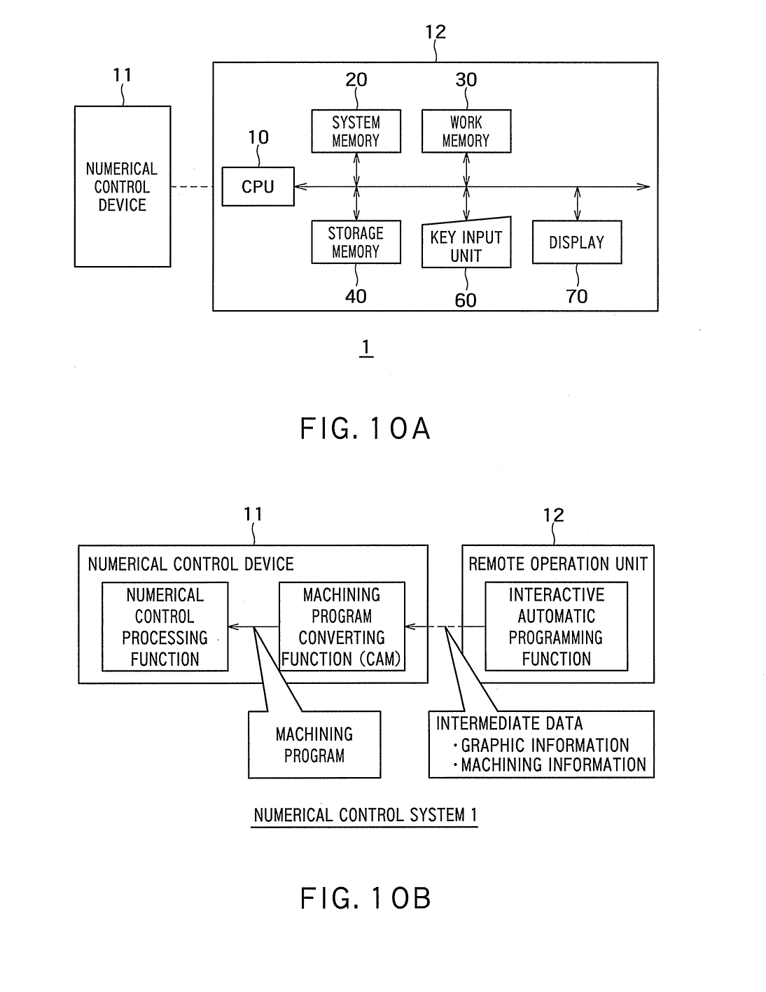

FIG. 10A is a block diagram showing a configuration of the numerical control system 1 according to a second embodiment of the present invention. FIG. 10B is a conceptual diagram schematically showing functions of the numerical control system 1 according to the second embodiment.

The numerical control system 1 according to the second embodiment includes a numerical control device 11 and a remote operation unit 12 separated from the numerical control device 11. The remote operation unit 12 includes the CPU 10, the system memory 20, the work memory 30, the storage memory 40, the key input unit 60, and the display 70 and is connected to the numerical control device 11 to be capable of performing communications therewith.

The remote operation unit 12 is, for example, a personal computer or a tablet terminal and executes the interactive automatic programming function (generation of the graphic information and the machining information) in the first embodiment. The remote operation unit 12 is used to select the basic shapes or the unit shapes and generates the graphic information and the machining information. A generation method of the graphic information and the machining information can be identical to that according to the first embodiment. After generating a machining shape, the remote operation unit 12 transmits the machining shape to the numerical control device 11.

The numerical control device 11 receives the graphic information and the machining information from the remote operation unit 12 and executes machining program conversion and numerical control processing. Accordingly, in the second embodiment, the remote operation unit 12 has the interactive automatic programming function and the numerical control device 11 has the CAM function.

Alternatively, the remote operation unit 12 can have the CAM function. In this case, it suffices that the remote operation unit 12 converts the graphic information and the machining information to a machining program and then transmits the machining program to the numerical control device 11.

Which one of the numerical control device 11 and the remote operation unit 12 has the CAM function can be determined according to processing capacities and loads of CPUs (systems) of the numerical control device 11 and the remote operation unit 12. For example, the CAM function can be provided to one of the numerical control device 11 and the remote operation unit 12 having a larger processing capacity. Alternatively, the CAM function can be provided to one of the numerical control device 11 and the remote operation unit 12 having a lower load.

According to the second embodiment, an operator can operate the remote operation unit 12 to create the graphic information and the machining information at a position distant from the numerical control device 11. Generally, machining of an object is practically performed near the numerical control device (machining device) 11, where environments are not so good and the operator often uses gloves. Accordingly, it is unfavorable to operate the key input unit 60 of the numerical control device 11 for a long time and the gloves cause the operation of the key input unit 60 to be difficult. Particularly when the display 70 of a touch panel type is operated, the gloves may hamper the operation.

On the other hand, according to the second embodiment, an operator can create the graphic information and the machining information by operating the remote operation unit 12 separated from the numerical control device 11. Therefore, the operator can create the graphic information and the machining information, for example, in an office distant from the numerical control device 11. In this case, environments are relatively good and the gloves are not required. Therefore, the remote operation unit 12 can be easily operated. Because the gloves are not required, no problem occurs even when the remote operation unit 12 is a touch panel tablet terminal. The operator can change the parameters of the selection shapes easily by the pinch operation as mentioned above.

Furthermore, the created graphic information and machining information can be wirelessly transmitted from the remote operation unit 12 to the numerical control device 11. The numerical control device 11 can perform the machining program conversion immediately with the reception of the graphic information and the machining information as a trigger. Accordingly, the numerical control device 11 can prepare the machining program before an operator arrives to the numerical control device 11 after the graphic information and the machining information are created. As a result, the operator can start the numerical control processing immediately after arrival to the numerical control device 11.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A numerical control system to be used for a machining device machining a machining target into a desired shape, the system comprising:
a storage unit storing a plurality of basic shapes therein;
a display unit displaying a plurality of selection shapes selected by an operator from among the basic shapes; and
a computing unit extracting areas enclosed by line segments between intersections of contour lines of the selection shapes as unit shapes, respectively, when the selection shapes overlap with one another and to combine a plurality of selection unit shapes selected by the operator from among the unit shapes, thereby generating a contour of the desired shape.

2. The system of claim 1, wherein the computing unit allocates identifiers for identifying the unit shapes to the unit shapes, respectively, and an operator selects ones of the identifiers in order to select ones of the unit shapes corresponding to the selected identifiers.

3. The system of claim 1, wherein the computing unit erases line segments respectively shared by the selection unit shapes to cause the selection unit shapes to be the desired shape having a single closed contour.

4. The system of claim 2, wherein the computing unit erases line segments respectively shared by the selection unit shapes to cause the selection unit shapes to be the desired shape having a single closed contour.

5. The system of claim 1, wherein the computing unit determines a machining start point and a machining direction according to selection by an operator after generating the contour of the desired shape.

6. The system of claim 2, wherein the computing unit determines a machining start point and a machining direction according to selection by an operator after generating the contour of the desired shape.

7. The system of claim 1, wherein the machining device comprises an operation unit to be used to select the selection shapes or the selection unit shapes.

8. The system of claim 1, comprising a remote operation unit being separated from the machining device, the remote operation unit including the storage unit, the display unit, and the computing unit, and being used to select the basic shapes or the unit shapes, wherein
the remote operation unit transmits the desired shape to the machining device after generating the desired shape.

9. A numerical control data generation method to be executed in a numerical control system comprising a storage unit storing a plurality of basic shapes therein, a display unit displaying the basic shapes, and a computing unit generating a contour of a desired shape, the method being used for a machining device machining a machining target into the desired shape, the method comprising:
displaying a plurality of selection shapes selected by an operator from among the basic shapes;
extracting areas enclosed by line segments between intersections of contour lines of the selection shapes as unit shapes, respectively, when the selection shapes overlap with one another; and
combining a plurality of selection unit shapes selected by the operator from among the unit shapes in order to generate a contour of the desired shape.

10. The method of claim 9, wherein the computing unit allocates identifiers for identifying the unit shapes to the unit shapes, respectively, and an operator selects ones of the identifiers in order to select ones of the unit shapes corresponding to the selected identifiers.

11. The method of claim 9, wherein the computing unit erases line segments respectively shared by the selection unit shapes to cause the selection unit shapes to be the desired shape having a single closed contour.

12. The method of claim 10, wherein the computing unit erases line segments respectively shared by the selection unit shapes to cause the selection unit shapes to be the desired shape having a single closed contour.

13. The method of claim 9, further comprising determining a machining start point and a machining direction according to selection by an operator after generating the contour of the desired shape.

14. The method of claim 10, further comprising determining a machining start point and a machining direction according to selection by an operator after generating the contour of the desired shape.

15. The method of claim 9, wherein
the numerical control system comprises a remote operation unit separated from the machining device and used to select the basic shapes or the unit shapes, and
the method further comprises transmitting the desired shape from the remote operation unit to the machining device after generating the desired shape.
